(19) United States
(12) Patent Application Publication
(10) Pub. No.: US 2008/0159640 A1
(43) Pub. Date: Jul. 3, 2008

(54) Document Image Encoding Decoding

(76) Inventors: Chaoqiang Liu, Singapore (SG); Tao Xia, Singapore (SG)

Correspondence Address: PATTON BOGGS, LLP, 2001 ROSS AVENUE, SUITE 3000, DALLAS, TX, 75201, US

(21) Appl. No.: 10/578,581

(22) PCT Filed: Nov. 6, 2004
(86) PCT No.: PCT/SG04/00366

§ 371 Date: Mar. 19, 2007

Related U.S. Application Data
(60) Provisional application No. 60/517,928, filed on Nov. 6, 2003.

(51) Int. Cl. G06K 9/36

(52) U.S. Cl. 382/239

(57) ABSTRACT

A method of encoding a document image, the method comprising extracting one or more picture areas from the document image; extracting one or more character areas from the document image; obtaining a background image by subtracting the image and character areas from the document image; classifying character blocks of the character areas with reference to dynamically generated templates; and encoding the background image utilising a SAQ wavelet encoder.

### FIELD OF INVENTION

The present invention relates broadly to a method and system for encoding a document image, to a method and system for decoding a compressed document image stream, to a computer readable data storage medium having stored thereon code means for instructing a computer to execute a method of encoding a document image; and to a computer readable data storage medium having stored thereon code means for instructing a computer to execute a method of decoding a compressed document image stream.

### BACKGROUND

As electronic storage, retrieval and distribution of documents becomes faster and cheaper, digital documents are being increasingly used. Typically, documents are being re-typed and converted to HTML or Adobe's PDF format. Alternatively, an Optical Character Recognition (OCR) technique may be used to convert a hard copy of a document into a digital document. Unfortunately, these techniques are still found to be far from suitable for faithfully translating a scanned document into a web page, and much of the visual aspect of the original document is likely to be lost.

Recently, image-based approaches to digital documents have been proposed. One such “image-based approach” to digital documents is to store and to transmit documents as one or more images. Traditional image compression standards such as JPEG and GIF are found to be inappropriate for document images. Although such image compression standards are suitable for continuous-tone images (i.e. for most pictures of natural scenes), these standards are not suitable for sharp edges of character images. On the other hand, a scanned document tends to be quite large if one wants to preserve the readability of the text.

It is with the knowledge of the above mentioned background and concerns that the present invention has been made and is now reduced to practice.

### SUMMARY

In accordance with a first aspect of the present invention there is provided a method of encoding a document image, the method comprising extracting one or more picture areas from the document image; extracting one or more character areas from the document image; obtaining a background image by subtracting the image and character areas from the document image; classifying character blocks of the character areas with reference to dynamically generated templates; and encoding the background image utilising a SAQ wavelet encoder.

The extracting of the picture areas and/or the character areas may comprise marking blocks partitioned from the document image based on features of wavelet coefficients of the respective blocks.

The extracting of the pictures areas may comprise a hierarchical extraction comprising extracting picture blocks from the document image to generate one or more initial picture areas and refining the initial picture areas by extracting picture pixels adjacent to the initial picture areas.

The extracting of the character areas from the document image may comprise utilising a customised definition of the connectivity of the pixels.

The method may further comprise generating style data as a description of the templates and character blocks.

The classifying the character blocks may comprise a hierarchical matching comprising matching the style of each character block based on the style data and then matching each character block against selected ones of the templates based on the style data matching.

The classifying of the character blocks based on the templates may comprise morphological matching.

The morphological matching may comprise matching algorithms M₁ and M₂,

Different structure elements may be utilised for different types of document images.

The method may further comprise bit plane storage of a compressed stream of the document image in the order of character areas, picture area and background image for progressive decoding.

In accordance with a second aspect of the present invention there is provided a method of decoding a compressed document image stream, the method comprising extracting one or more picture areas from the compressed document image stream; extracting one or more character areas from the compressed document image stream; extracting a background image from the compressed data image stream; identifying character blocks of the character areas with reference to dynamically generated templates in the compressed document image stream; decoding the background image utilising a wavelet based SAQ method; and constructing a decoded document image by adding the picture areas, the character areas and the background image.

In accordance with a third aspect of the present invention there is provided a computer readable data storage medium having stored thereon code means for instructing a computer to execute a method of encoding a document image, the method comprising extracting one or more picture areas from the document image; extracting one or more character areas from the document image; obtaining a background image by subtracted the image and character areas from the document image; classifying character blocks of the character areas with reference to dynamically generated templates; and encoding the background image utilising a wavelet based SAQ method.

In accordance with a fourth aspect of the present invention there is provided a computer readable data storage medium having stored thereon code means for instructing a computer to execute a method of decoding a compressed document image stream, the method comprising extracting one or more picture areas from the compressed document image stream; extracting one or more character areas from the compressed document image stream; extracting a background image from the compressed data image stream; identifying character blocks of the character areas with reference to dynamically generated templates in the compressed document image stream; decoding the background image utilising a wavelet based SAQ method; and constructing a decoded document image by adding the picture areas, the character areas and the background image.

In accordance with a fifth aspect of the present invention there is provided a system for encoding a document image, the system comprising means for extracting one or more picture areas from the document image; means for extracting one or more character areas from the document image; means for obtaining a background image by subtracted the image and character areas from the document image; means for classifying character blocks of the character areas with reference to dynamically generated templates; and means for encoding the background image utilising a wavelet based SAQ method.

In accordance with a sixth aspect of the present invention there is provided a system for decoding a compressed document image stream, the system comprising means for extracting one or more picture areas from the compressed document image stream; means for extracting one -or more character areas from the compressed document image stream; means for extracting a background image from the compressed data image stream; means for identifying character blocks of the character areas with reference to dynamically generated templates in the compressed document image stream; means for decoding the background image utilising a wavelet based SAQ method; and means for constructing a decoded document image by adding the picture areas, the character areas and the background image.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a block diagram illustrating an encoder process in an example embodiment.

FIG. 2 shows a block diagram illustrating a decoder process in an example embodiment.

FIG. 3 shows a block diagram illustrating an image block extractor process in an example embodiment.

FIG. 4 shows a block diagram illustrating a process for clustering of character images in an example embodiment.

FIG. 5 is a schematic drawing illustrating a computer system for implementing the method and system of an example embodiment.

### DETAILED DESCRIPTION

Embodiments of the present invention provide an image compression technique for classifying, matching and identifying document images based on a wavelet compression method. This method may be referred to as a wavelet document image compression (WDIC) method. More specifically, in embodiments of the present invention, the character and picture components may be separated from the backgrounds of one or more original document images and different methods used to compress each of those components. More generally, embodiments of the present invention may also be applied to other special documents such as particularly important historical documents, scientific papers with mathematical or chemical formulae, software documents and some handwritten signatures.

Embodiments of the present invention provide an approach for compression of document images enabling a high-quality version of one page of a document image to be transferred at very high compression ratios.

The example embodiments comprise a number of novel algorithms for an improved document image compression method. Two main categories of picture areas and character areas may be extracted from the document image and the background image encoded by subtracting these two category areas from document images, in the example embodiments.

The character image may be encoded with an extent-based morphological matching, clustering and wavelet compression algorithm. A picture image may be encoded with a wavelet-based compression algorithm, which is suitable for grey scale images. A background image may also be encoded with a wavelet-based successive approximation quantization (SAQ) compression algorithm.

WDIC, in example embodiments, is a progressive code. WDIC provides progressive decoding not only on background images, but also on character images.

In the following sections the example embodiments are described. The features of WDIC of the example embodiments comprise special image segmentation for a document image, fast classification, a morphological matching and clustering algorithm for character images, and a wavelet-based compression algorithm for picture images. Results from an actual implementation experiment showed a significant performance improvement over prior art methods in respect of two aspects. Firstly, WDIC allows a highly efficient compression format and secondly, a progressive range of compression rate scalability to be achieved in the example embodiments.

It is assumed that the intensity of background pixels has a possible maximum intensity value Iₘₐₓ and the intensity of characters, pictures is positive in the example embodiment Firstly, the image is posterized into 3 levels as below.

$$F ( v ) = \{ \begin{matrix}0 & when I ( v ) \geq {T}_{0} \\ 1 & when {T}_{1} \leq I ( v ) < {T}_{0} , \\ 2 & when I ( v ) < {T}_{1}\end{matrix}$$

where I(v) is the intensity of the pixel at v=(vₓ, v_{y}), and T₁=Iₘₐₓ/2,

where T₀ is calculated in step 301.

The following algorithm is performed at all untraced pixels u with F(u)=2.

$$1. S = φ , {S}_{1} = \{ u \} , W = \frac{r}{72} \times C ,$$

C is slightly larger than font size of most characters/letter. (default C=24)

2. Find v ε S₁, {νᵢ}ᵢ₌₁⁸ represent eight neighbor pixels of ν in clockwise order, among them {ν₁, ν₃, ν₅, ν₇} are 4 neighbor pixels of ν.

Define vᵢ₊₈ₖ = vᵢ, k ε Z . S = S∪{v}, S₁ = S₁\{v}

| 3. | for vᵢ, i = 1, . . . , 8, \|v_{i,x} − uₓ\| ≦ W, and \|v_{i,y} − u_{y}\| ≦ W | |
|---|---|---|
| | a. | if i = 1, 3, 5, 7, |

| | |
|---|---|
| i. | if F(v) = 2 and (F(vᵢ) = 2 or (F(vᵢ) = 1 and F(vᵢ₋₁) + F(vᵢ₊₁) ≧ |

then S₁ = S₁ ∪{vᵢ}

| | |
|---|---|
| ii. | if F(v) = 1 and (F(vᵢ) = 2 and (F(vᵢ₋₂) + F(vᵢ₊₂) ≧ 2)) |

| then S₁ = S₁ ∪{vᵢ} | |
|---|---|
| b. | if i = 2, 4, 6, 8, |

if F(v) = 2 and (F(vᵢ) = 2 and F(vᵢ₋₁) + F(vᵢ₊₁) ≧ 1) then S₁ = S₁ ∪{vᵢ}

| | |
|---|---|
| 4. | if S₁ ≠ φ, go to step 2 |
| 5. | A = {(x,y)\|χₘᵢₙ ≦ x ≦ xₘₐₓ, yₘᵢₙ ≦ y ≦ yₘₐₓ} represents a |

character image block.
$where {x}_{min} = {min}_{v ε S} \{ {v}_{x} \} , {x}_{max} = {max}_{v ε S} \{ {v}_{x} \} , {y}_{min} = {min}_{v ε S} \{ {v}_{y} \} , {y}_{max} = {max}_{v ε S} \{ {v}_{y} \}$

After character image block A is extracted and saved into the character block list, the pixels in this block are marked as the traced pixels and the value of the pixels in the character list block are changed to 255. The same procedure starts from untraced pixels satisfying F(u)=2 until no such pixel exists.

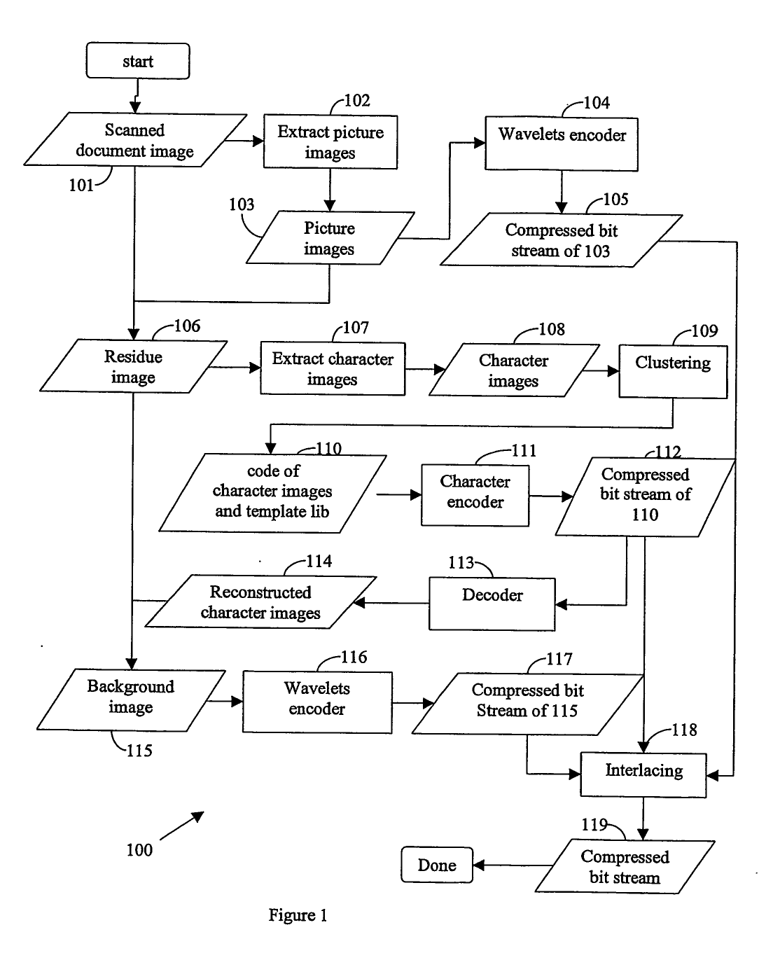

The character images 108 are the blocks representing the lines and characters extracted at step 107 from the residue image 106 in the example embodiment. Process step 109 clusters the character images 108 hierarchically. Step 109 will be described in further detail in steps 401 to 413 below. Process step 109 outputs data 110 comprising the character template library and the code of every character block outputted from step 109. The code of the character blocks includes the absolute coordinates of the block in the original image 101 and the index of the template the block uses. At step 111 the process of FIG. 1 encodes the character codes of the character blocks and character template library by an SAQ encoder in the example embodiment.

The output 112 of step 111 is a compressed bit stream for the characters. While the data 112 is passed to the process step 118, the data will be decoded by a decoder at step 113 which is the counterpart of the SAQ encoder used at step 104. The reconstructed character images 114 are used to generate the background image 115. Process step 116 utilises a SAQ wavelet encoder for grey scale images in the example embodiment. Reference is made to J. M. Shapiro, “Embedded Image Coding Using Zerotrees of Wavelet Coefficients”, IEEE Trans. On Signal Processing, Vol. 41, No. 12, December 1993, pp. 3445-3426 and to Said, and W. A. Pearlman, “A New Fast and Efficient Image Codec Based on Set Partitioning in Hierarchical Trees”, IEEE Trans, on Circuits and Systems for Video Technology, Vol. 6, No. 3, June 1996, pp. 243-250 for details of a suitable encoding process.

The compressed bit stream 117 for the background image 115 is passed to the process step 118. The process step 118 organizes the compressed bit stream of picture image blocks, character image blocks and the background image to generate the compressed data bit stream 119 for the whole document image.

The compressed data bit stream 119 is organized as described in the following example embodiment. The document image header and character codes of character blocks and location information of picture image blocks are saved first. Then the compressed stream for the first two most significant bit planes of a character template library are saved. In the compressed stream of pictures and background images, the stream for the bit planes whose value is greater or equal than the value of the second most significant bit plane of character pictures is saved next. Finally the remaining compressed streams for characters, pictures and background image are added one bit plane followed by another from the most significant one to the least significant one in an interlaced manner. This interlaced pattern saves compressed stream of character templates first and then the stream of pictures and background for the same bit plane, in the example embodiment. Such organization may ensure the progressive decoding of the document image in the example embodiment. In other words, one can obtain the document image from coarsest version to the finest version.

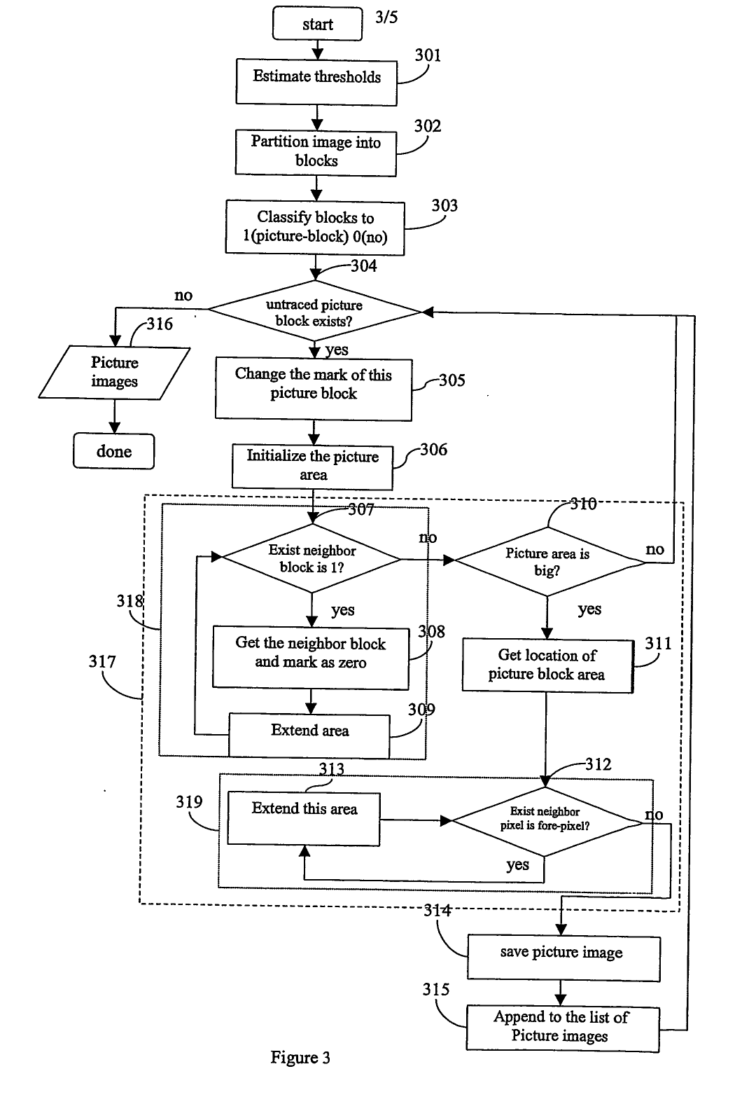

The picture image block extractor process step 102 is described in further detail in the following, with reference to FIG. 3.

As seen in FIG. 3, process step 301 estimates the peak value P₀ of the histogram of document image, threshold T₀=(T₁+P₀)/2, the pixels of intensity of pixel less than T₀ are classified as foreground pixel, other pixels are background pixels.

Process step 302 partitions the entire document image into blocks with size

w×w where w=2^{└log}₂^{r/4┘}

and r is at scanned resolution.

Process step 303 classifies blocks in to two types: picture blocks marked by 1 and nonpicture blocks marked by 0. The classification is based on the statistical features of wavelet decomposition of blocks. The procedure is as following in the examples embodiment.

Using the wavelet filter to decompose the block once as conventional wavelet decomposition of image. For the computation efficiency, the sum of filter coefficients is 2 and the suggested filter for this procedure is a Haar wavelet filter. The diagram below shows this procedure. LL, LH, HL and HH are the notations of lowest frequency component to highest frequency component as will be appreciated by a person skilled in the art.

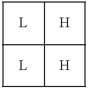

In general, a document image is typically composed of a large portion of characters and edge regions, together with a relatively smaller portion of homogeneous regions. Homogeneous regions have the least variation. Characters regions have moderate variation; and lines show the most variation.

$$g ( c ) = \{ \begin{matrix}1 & when \vert c \vert > A \\ 0 & otherwise\end{matrix}$$

where A is a predefined threshold (default A=16 for images with 256 as maximum intensity value, in an example embodiment) and c is the wavelet coefficients.

The statistical variable used in the classification is as follows:

$${count}_{H} = \frac{{\sum }_{( i , j ) ∈ H} g ( {C}_{i , j} )}{1.5 W} ,$$

where H=HL∪LH∪HH

$${average}_{LL} = \frac{{\sum }_{( i , j ) ∈ LL} {C}_{i , j}}{4 {S}_{LL}}$$

where S_{LL}, is the total number of wavelet coefficients of LL.

If count_{H}<B and average_{LL}<(T₀+T₁)/2, where B is the predetermined threshold whose default value is 3, the block is marked as picture block, otherwise the block is marked as nonpicture block.

Switch 304 checks whether untraced picture blocks exist. If the answer is NO, all picture blocks are saved in data 316 already and the process 102 of FIG. 3 finishes.

Otherwise, the next untraced picture block is identified in step 305 the mark of the next untraced picture block is changed to zero, and the picture area is initialised to the minimum rectangle containing current block in the next process step 306.

The process step 317 as seen in FIG. 3 extracts the rectangle area of the picture image and consists of two steps in the example embodiment. Firstly, process step 318 extracts the picture blocks from the picture image. Then the rectangle area will further grow to neighbouring pixels in process step 319 if necessary, as seen in FIG. 3.

Switch 307 checks whether there is a neighbour block of the current picture area whose mark is 1. If the answer is YES, the neighbour block is marked 0 in step 308 and the picture area is extended to a new rectangle area containing this block in process step 309, the process step 318 returns to switch 307. If the answer is NO, all neighbour blocks are not picture blocks. Process step 318 is completed and the process of FIG. 3 proceeds to switch 310.

Switch 310 checks whether the rectangle picture area is big enough by comparing the length and width to the preset value (default 2W). If answer is NO, there is no picture area found and the process of FIG. 3 turns to switch 304. Otherwise, the answer is YES, and the location information of the picture area is stored in step 311.

Process step 319, as seen in FIG. 3, comprising the following steps refines the picture area in the example embodiment. Switch 312 checks whether there is a fore-pixel in the neighbour pixels of current area. If the answer is YES, process step 313 extends the picture area to the new rectangle picture area containing the found fore-pixel and the process 319 returns to switch 312. If the answer is NO, all neighbour pixels of current picture area are back-pixels. Process step 319 finishes and this rectangle picture is saved as a picture image area in process step 314. Process step 315 appends this picture image area to the list of picture images and the process of FIG. 3 returns to switch 304.

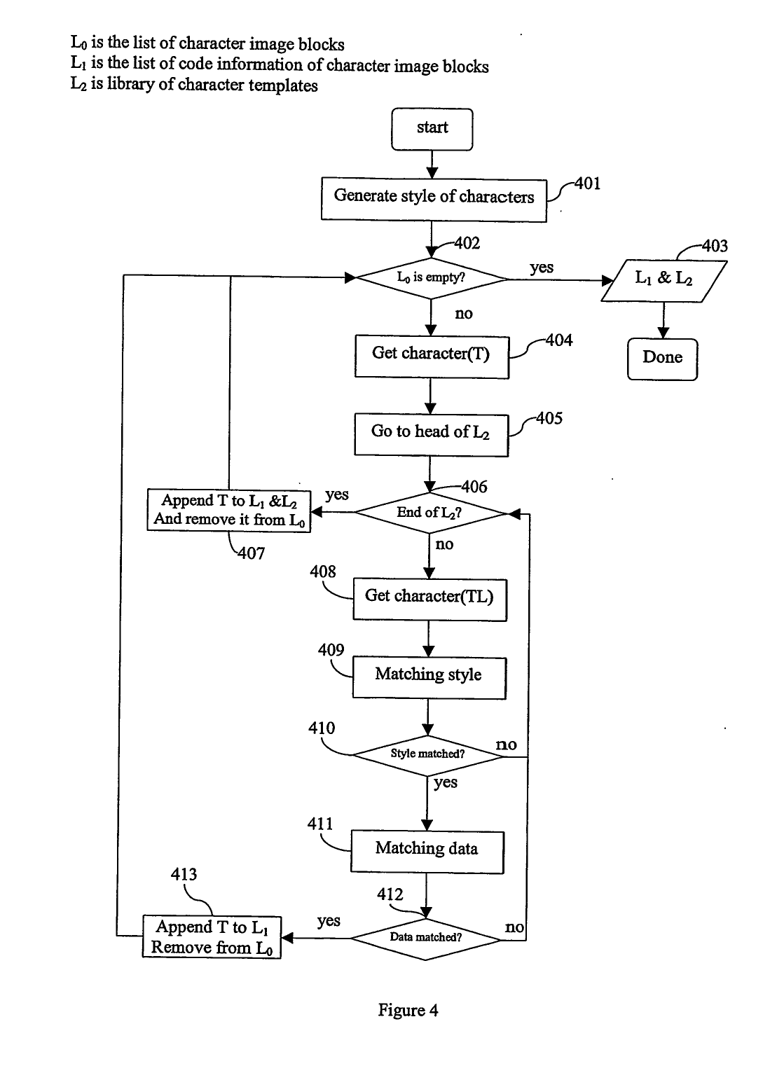

With reference to FIG. 4, process step 401 generates the style of characters

Ω={(i,j)|I₁(i,j)<T₂,i=0,1, . . . , h−1,j=0,1, . . . , w−1)

where I₁(i,j) is intensity of pixel at coordinates (i,j) in character image block I₁ and block distance of two pixels is defined as d((i₁,j₁), (i₂,j₂))=|i₂−i₁|+|j₂−j₁|.

Then the style of this character is defined as (w,h,d₁ᵣ,d_{1b},dᵣₗ,d_{rb},) where

$${d}_{lt} = {min}_{( i , j ) ∈ Ω} ( d ( ( 0 , 0 ) , ( i , j ) ) ) , \\ {d}_{l b} = {min}_{( i , j ) ∈ Ω} ( d ( ( 0 , h - 1 ) , ( i , j ) ) )$$

$${d}_{rt} = {min}_{( i , j ) ∈ Ω} ( d ( ( w - 1 , 0 ) , ( i , j ) ) ) , \\ {d}_{rb} = {min}_{( i , j ) ∈ Ω} ( d ( ( w - 1 , h - 1 ) , ( i , j ) ) )$$

Three sets L₀, L₁, L₂ may be defined for process step 109. L₀ is the collection of character images blocks. L₁ is the collection of the character code of the character image blocks consisting of the index of the matched character template in the character template library and the locations of the character image blocks. L₂ is library of character templates used to save the images of character templates. Switch 402 checks whether L₀ is empty, if the answer is YES, all character blocks have been processed, then data 403 comprising L₁ and L₂ will be outputted and the process 109 concludes. Otherwise, the answer is NO in step 402, the next character block T in L₀ is retrieved in process step 404. Process step 404 is the process of matching character block T against templates in L₂. Starting from the head of L₂, check whether all templates in L₂ have been used at switch 406.

If the answer is YES, T is a new type of character, in step 407 T is appended to L₂ as a new character template TL, the code information of T against TL is saved to L₁, and T is removed from L₀, then the process returns to switch 402.

Otherwise, if the answer is NO in 406, the character template TL is retrieved from L₂ in step 408. T is matched against TL by two steps, first match T against TL in process step 409. In process step 409, we compute the absolute values of differences of all entries between style of T and style of TL. Switch 410 checks the result of process 409, if one of the absolute values is greater equal than predetermined threshold, the answer is NO, the process of FIG. 4 proceeds to step 406. If the answer is YES, then match T against TL by morphological character matching method in process step 411.

Process step 411 uses a morphological approach in the example embodiment with which the matching of two characters is fast and accurate compared to conventional matching methods such as matching by grey scale similarity. The new measurement based on morphological approach in the example embodiment may perform better than Euclidean distance measurement and Hausdorff measurement in the case of a noisy environment due to the stability of the measurement.

The morphological operator in the example embodiment measures the size of the difference image of two images (i.e., one is the template and the other is character block). Assumes the two images are f and g, the difference image f−g is defined as follows:

$$\begin{matrix}( f - g ) ( x , y ) = \{ \begin{matrix}1 , & \begin{matrix}F ( {( x , y )}_{f} ) + F ( {( x , y )}_{g} ) < 4 and \\ \vert f ( x , y ) - g ( x , y ) \vert > {C}_{M}\end{matrix} \\ 0 , & otherwise\end{matrix} , \\ threshold {C}_{M} = 32.\end{matrix}$$

The difference image f−g is a binary image. In other words, the difference image f−g is a binary set.

The size of set A of structure element B may be defined as

$${e ( A )}_{B} = {sup}_{α} \{ A \cdot α B \neq φ \} , α ∈ ℜ$$

where A∘B is normal morphological open operator.

The new measurement of the difference between two binary sets may be defined as S_{B}(f,g)=e(f−g)_{B}, where B is square structure element of size 1.

The similarity measure of two sets f, g is M(f,g)=max{S_{B}(f−g), S_{B}(g−f)}. The new measurement is symmetric in the sense of the distortion is concave distortion or convex distortion; however, the Hausdorff measurement is not symmetric, as will be appreciated by the person skilled in the art. Reference is made to W. Gong, Q. Y. Shi, and M. D. Cheng, Shape and image matching by use of morphology, Proc. 11^{th} Int. Conf. On Pattern Recognition, vol. 2, 673-676, The Hague, The Netherlands, 1992

If the measure is less than the average size of the noise region, the matching is a success. A fast algorithm may be defined in the example embodiment based on this theory for matching of a character problem. The measure of the difference is modified as M(f, g)=S_{B}(f−g). For the matching of the character image, e.g. with resolution no less than 72, if the measure is less than 2, the matching of character against template is a success. The algorithm may be defined as follows:

Algorithm M₁

| | |
|---|---|
| 1. | Suppose (f − g)(x) is a sequence with length m. x ← 0, |
| 2. | if (f − g)(x) = 0, go to step 5 |
| 3. | if (f − g)(x + 1) = 0, (f − g)(x) ← 0, go to step 5 |
| 4. | x ← x + 1 |
| 5. | if (x < m − 1) x ← x + 1, go to step 2 |
| 6. | end |

Algorithm M₂

| | |
|---|---|
| 1. | Suppose (f − g)(x) is a sequence with length m. x ← 0, |
| 2. | if (f − g)(x) = 1 and (f − g)(x + 1) = 1, go to step 5 |
| 3. | if (x < m − 1) x ← x + 1, go to step 2 |
| 4. | character matches against template, go to step 6 |
| 5. | character does not match against template, go to step 6 |
| 6. | end |

The condition is weak or does not depend on the structure element used in the algorithm M₁ and the associated part of algorithm M₂ in the example embodiment. Here the condition is strong means that matching a character against template is difficult On the contrary, the condition is weak means matching a character against a template is very easy. Strong condition will decrease the compression ratio slightly but weak condition will generate false matching and the reconstructed character may not be correct when the scanned document image quality is very poor. The order of line, circle to square corresponds to the conditions from strong to weak.

The following is noted:

If algorithm M₁ performs only along row direction, the structure element used in the matching algorithm is a line of horizontal direction in the example embodiment. This element is found to be good enough for e.g. English character matching.

If algorithm M₁ performs only along column, the structure element used in the matching algorithm is a line of vertical direction in the example embodiment.

If algorithm M₁ performs along both row and column directions, the structure element used in the matching algorithm is circle in the example embodiment Circle structure element is found to work well for character of most languages.

If algorithm M₁ performs along row direction followed by column direction and then performs along column direction followed by row direction, the structure element used in the matching algorithm is square in the example embodiment.

For the structure element of lines we may only need to apply algorithm M₂ along same direction as M₁ does. For the structure element circle algorithm M₂ performs at either horizontal direction or vertical direction in the example embodiment. For the structure element square, algorithm M₂ performs at both horizontal and vertical directions before we conclude that the match is success in the example embodiment.

Returning to the process of FIG. 4, switch 412 checks whether T matches against TL. If the answer is NO, the process of FIG. 4 returns to switch 406. Otherwise, the answer is YES, information of T is appended to L₁ and code of T is index of pattern TL in L₁, then the process step 413 removes T from L₀, and then the process of FIG. 4 proceeds to switch 402.

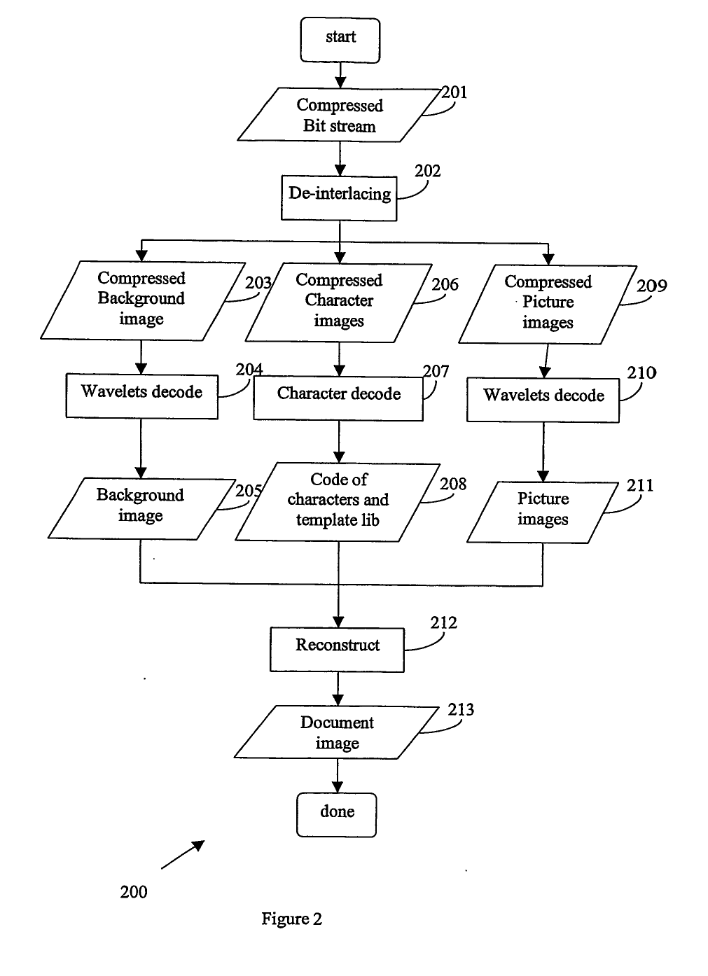

FIG. 2 illustrates the decoder process 200 in the example embodiment, that is the reverse process of the encoder 100. Decoder process 200 begins from a compressed bit stream 201 of the document image. Process step 202 separates the bit stream 201 into three parts based on the formats of the compressed document image described in step 118. These three parts are a compressed bit stream 203 of background image, compressed bit stream 206 of character image blocks and compressed bit stream 209 of picture image blocks.

Data 203 is decoded by wavelet based SAQ decoder 204 to generate the background image. Data 206 is decoded by a character decoder at process step 207 to generate the information of character codes of character image blocks and character template library. Data 209 is decoded by SAQ wavelet decoder at step 210 to generate the picture image blocks 211. Data 205, 208 and 211 may be combined to generate the document image 213 in process step 212.

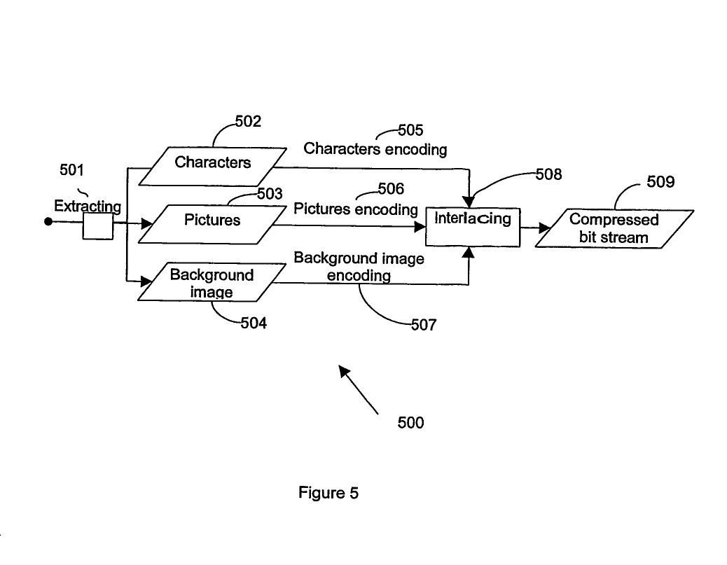

The method and system of the example embodiment can be implemented on a computer system 500, schematically shown in FIG. 5. It may be implemented as software, such as a computer program being executed within the computer system 500.

The computer system 500 comprises an extracting module 501, which extracts the characters 501, pictures 502 and background image 503. The character encoding module 505 and picture encoding module 506 and background image encoding module 507 compress the characters 501, pictures 502 and background image 503 respectively. The output compressed stream is interlaced in module 508.

The compressed bit stream 509 is the compressed document image generated by document image encoding.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of encoding a document image, the method comprising:
extracting one or more picture areas from the document image;
extracting one or more character areas from the document image;
obtaining a background image by subtracting the image and character areas from the document image;
classifying character blocks of the character areas with reference to dynamically generated templates; and
encoding the background image utilising a SAQ wavelet encoder.

2. The method as claimed in claim 1, wherein the extracting of the picture areas and/or the character areas comprises marking blocks partitioned from the document image based on features of wavelet coefficients of the respective blocks.

3. The method as claimed in claims 1 or 2, wherein the extracting of the pictures areas comprises a hierarchical extraction comprising extracting picture blocks from the document image to generate one or more initial picture areas and refining the initial picture areas by extracting picture pixels adjacent to the initial picture areas.

4. The method as claimed in any one of claims 1 to 3, wherein the extracting of the character areas from the document image comprises utilising a customised definition of the connectivity of the pixels.

5. The method as claimed in any one of claims 1 to 4, further comprising generating style data as a description of the templates and character blocks.

6. The method as claimed in claim 5, wherein the classifying the character blocks comprises a hierarchical matching comprising matching the style of each character block based on the style data and then matching each character block against selected ones of the templates based on the style data matching.

7. The method as claimed in any one of claims 1 to 6, wherein the classifying of the character blocks based on the templates comprises morphological matching.

8. The method as claimed in claim 7, wherein the morphological matching comprises matching algorithms M₁ and M₂.

9. The method as claimed in claim 8, wherein different structure elements are utilised for different types of document images.

10. The method as claimed in any one of claims 1 to 9, further comprising bit plane storage of a compressed stream of the document image in the order of character areas, picture area and background image for progressive decoding.

11. A method of decoding a compressed document image stream, the method comprising:
extracting one or more picture areas from the compressed document image stream;
extracting one or more character areas from the compressed document image stream;
extracting a background image from the compressed data image stream;
identifying character blocks of the character areas with reference to dynamically generated templates in the compressed document image stream;
decoding the background image utilising a wavelet based SAQ method; and
constructing a decoded document image by adding the picture areas, the character areas and the background image.

12. A computer readable data storage medium having stored thereon code means for instructing a computer to execute a method of encoding a document image, the method comprising:
extracting one or more picture areas from the document image;
extracting one or more character areas from the document image;
obtaining a background image by subtracted the image and character areas from the document image;
classifying character blocks of the character areas with reference to dynamically generated templates; and
encoding the background image utilising a wavelet based SAQ method.

13. A computer readable data storage medium having stored thereon code means for instructing a computer to execute a method of decoding a compressed document image stream, the method comprising:
extracting one or more picture areas from the compressed document image stream;
extracting one or more character areas from the compressed document image stream;
extracting a background image from the compressed data image stream;
identifying character blocks of the character areas with reference to dynamically generated templates in the compressed document image stream;
decoding the background image utlising a wavelet based SAQ method; and
constructing a decoded document image by adding the picture areas, the character areas and the background image.

14. A system for encoding a document image, the system comprising:
means for extracting one or more picture areas from the document image;
means for extracting one or more character areas from the document image;
means for obtaining a background image by subtracted the image and character areas from the document image;
means for classifying character blocks of the character areas with reference to dynamically generated templates; and
means for encoding the background image utilising a wavelet based SAQ method.

15. A system for decoding a compressed document image stream, the system comprising:
means for extracting one or more picture areas from the compressed document image stream;
means for extracting one or more character areas from the compressed document image stream;
means for extracting a background image from the compressed data image stream;
means for identifying character blocks of the character areas with reference to dynamically generated templates in the compressed document image stream;
means for decoding the background image utlising a wavelet based SAQ method; and
means for constructing a decoded document image by adding the picture areas, the character areas and the background image.
